(19) United States
(12) Patent Application Publication
(10) Pub. No.: US 2017/0060919 A1
(43) Pub. Date: Mar. 2, 2017

(54) TRANSFORMING COLUMNS FROM SOURCE FILES TO TARGET FILES

(71) Applicant: salesforce.com, inc., San Francisco, CA (US)

(72) Inventors: Govardana Sachithanandam RAMACHANDRAN, Palo Alto, CA (US); Arun Kumar JAGOTA, Sunnyvale, CA (US); Kishore Kumar KONETI, Santa Clara, CA (US); Pawan NACHNANI, Union City, CA (US)

(21) Appl. No.: 14/840,547

(22) Filed: Aug. 31, 2015

(51) Int. Cl. G06F 17/30

(52) U.S. Cl. CPC G06F 17/30315; G06F 17/30179

(57) ABSTRACT

Transforming columns from source files to target files is described. A system associates a source column in a source file with an entity of multiple entities associated with target columns comprising a target file, based on a first set of features that describes contents of cells of a first source column that is adjacent to the source column, a second set of features that describes contents of cells of a second source column that is adjacent to the source column, and a third set of features that describes contents of cells of the source column. The system creates a mapping of the source column to a target column associated with the entity, and transforms the mapped source column to the target column in accord with the mapping.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

A database may be used to maintain many different types of structured data, such as contact data, company data, financial data, product data, health data, manufacturing data, etc. Structured data is often stored in a format suitable for spreadsheet analysis, such as comma-separated values (“CSV”), tab-delimited or tab-separated values (“TSV”), or an Excel file, for convenience of creation, analysis, and distribution. Data from the same entity may be represented very differently in different sources. Therefore, before importing such source data into a database, the source data may need to be normalized, such as the columns in the source data may need to be properly mapped to the entities of the target data model for the database. More specifically, this means that a sequence of target columns in the database represent defined entities of the data model. For example, the primary attributes of interest, or defined entities, of a contact record in a database may be: first_name, last_name, job_title, email address, phone_number, company_name, street, city, state, zip, and country. A contact record may be considered complete if at least four of the first five columns, namely first_name, last_name, job_title, and either email or phone_number, are not empty.

However, it can be difficult to accurately identify the defined entity with which a column in a source file should be associated. For example, some columns in a source file may be irrelevant, and therefore need to be ignored, such as “Hobbies” or “Alternate Fax.” Other source columns may have data that needs to be merged, such as a pair of source columns named “street1” and “street2,” which need to be mapped into a single target column street, or have data that needs to be split, such as when a source column “name” contains the full name of a person, and needs to be split to be mapped into the pair of target columns first_name and last_name.

Accordingly, it is desirable to provide techniques for accurately correlating columns in a source file with defined entities of a database model in order to transform the source file for importation into the data model.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 is an operational flow diagram illustrating a high level overview of a method for transforming columns from source files to target files, in an embodiment;

FIG. 2 illustrates example source file columns for transforming to target files, in an embodiment;

FIG. 3 illustrates a block diagram of an example of an environment wherein an on-demand database service might be used; and

FIG. 4 illustrates a block diagram of an embodiment of elements of FIG. 3 and various possible interconnections between these elements.

### DETAILED DESCRIPTION

### General Overview

Systems and methods are provided for transforming columns from source files to target files. As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system. Next, mechanisms and methods for transforming columns from source files to target files will be described with reference to example embodiments. The following detailed description will first describe a method for transforming columns from source files to target files. Next, example source file columns for transforming to target files are described.

In a significant number of source files, the header row is missing for the source data. In such cases, the only way to accurately identify the columns of interest and infer the data in their cells is to analyze the content of the file. For example, if a source column seems to contain first names, the source column should probably be mapped to the target entity first_name, especially if other evidence corroborates this conclusion, such as if the source column being evaluated is immediately to the left of the last_name column. Content-based analysis can be useful even when the file has a header row. For example, sometimes the name of a source column is ambiguous, such as when title could mean job title or salutation. Another example for content-based analysis is when the source column name is not recognized as a known alias for one of the target entities. In these examples, evaluation of the content of the source column provides additional information that can help make a decision as to what entity the source column represents.

In accordance with embodiments described herein, there are provided systems and methods for transforming columns from source files to target files. A system associates a source column in a source file with an entity of multiple entities associated with target columns comprising a target file, based on a first set of features that describes contents of cells of a first source column that is adjacent to the source column, a second set of features that describes contents of cells of a second source column that is adjacent to the source column, and a third set of features that describes contents of cells of the source column. The system creates a mapping of the source column to a target column associated with the entity, and transforms the mapped source column to the target column in accord with the mapping.

For example, the system associates a source column with a city entity type based on features that describe cell contents of the preceding source column as the street entity type, features that describe cell contents of the following source column as the state entity, and features that describe cell contents of the source column as the city entity type, because city columns are often found between street columns and state columns. The system creates a mapping of the source column to the city entity target column and uses the mapping to transform the source column to the city entity target column.

While one or more implementations and techniques are described with reference to an embodiment in which transforming columns from source files to target files is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the embodiments described herein may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

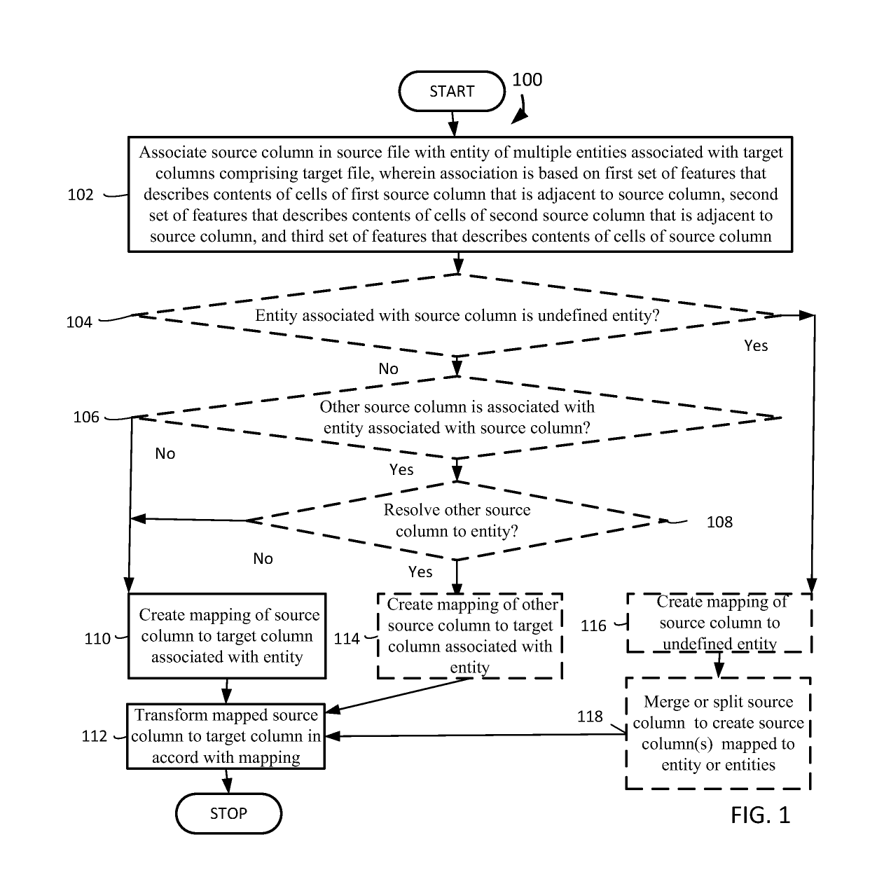

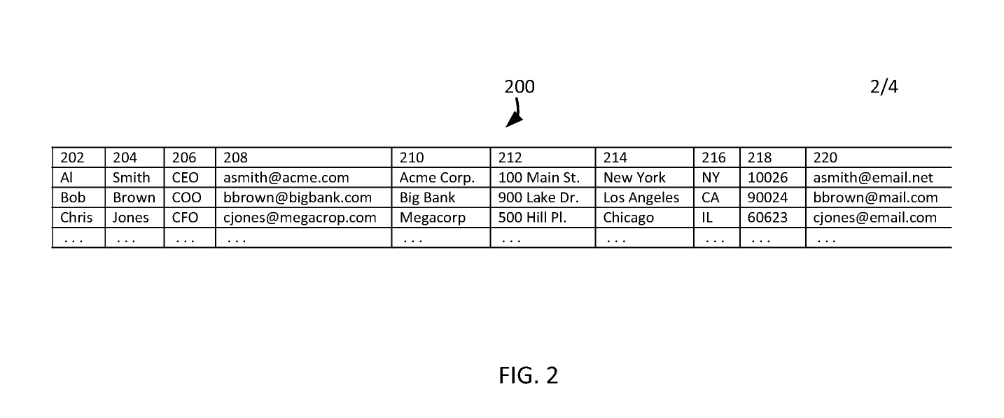

FIG. 1 is an operational flow diagram illustrating a high level overview of a method 100 for transforming columns is source files to target files. The examples of source file columns and source file column cell contents which are described below in reference to FIG. 1 are depicted in FIG. 2 and described below in reference to FIG. 2.

The system associates a source column in a source file with an entity of multiple entities associated with target columns comprising a target file, based on a first set of features that describes contents of cells of a first source column that is adjacent to the source column, a second set of features that describes contents of cells of a second source column that is adjacent to the source column, and a third set of features that describes contents of cells of the source column, block 102. For example and without limitation, this can include the system using a Pointwise Dynamic Conditional Random Field model to associate a source column with a city entity type based on features that describe cell contents of the preceding source column as a street entity type, features that describe cell contents of the following source column as a state entity type, and features that describe cell contents of the source column as the city entity type. The Pointwise Dynamic Conditional Random Field model determines a posterior score for the association between a source column and each entity type to reflect a level of confidence that the model should associate the source column with the corresponding entity type, and associates the source column with the entity type that has the highest posterior score.

The identification and evaluation of features that describe the contents of cells of a source column may begin with initialization for the source column, such as setting a counter row=1 and setting the maximum count for a representative sample size of rows, for example, maximum=20. The contents of a cell can be received into temporary storage for processing. The features describing the cell contents may be identified and evaluated using a probabilistic approximation. The probabilistic approximation can use a statistical classifier in an ordered approach to try and identify features that describe the cell contents as one of the multiple entities. This probabilistic approach may result in a confidence score, and the score for this cell can be stored. The row counter may be incremented by one, such as row=row+1. The row counter can be compared to the maximum count. If the row count is not greater than the maximum, then the process may return to identify and evaluate features describing the contents of the cell in the next row of the source column. If the row count is greater than the maximum, then an adequate representative sample of rows of this source column could have been evaluated.

Before going on to the next source column, however, additional scoring adjustments may be made for the current source column. A score for the entire source column can be aggregated. The scores of all cells in the column for the various entities may be combined together in a way that yields both a high recall and a high precision. For example, if features do not describe the contents of the first cell in a source column as a first name, but features describe the contents for 15 of the next 19 cells in the source column as a first name, then the guess that the column is a first_name column is highly plausible. More specifically, the statistical classifier can be called multiple times for the same cell contents in order to evaluate the probability for all entities. A single aggregated probability may then be derived for the entire source column.

Recognition of the various entities that might appear in source column cells can use a large and diverse training set of person first and last names, of job titles, of company names, and more. Such a training set may be readily available from a contacts database, such as the Jigsaw® database. Examples of descriptive features include whether a source column's cell contents are an email address, are a phone number, are a website, are all capital letters, start with a capital letter, are an abbreviation, are a single character, have preceding punctuation, have following punctuation, have punctuation in the preceding source column's cell contents, and have punctuation in the following source column's cell contents. More descriptive features include use of a Naive Bayes Classifier built on a Jigsaw® database, use of a cosine similarity score between a source column's cell contents and email prefixes, use of a cosine similarity score between a source column's cell contents and email domains, and use of a cosine similarity score between a source column's cell contents and website domains. Email prefixes have high similarities with first and last names, while company names have high similarities with email and website domains.

The Pointwise Dynamic Conditional Random Field model tries to predict the corresponding entity classes, one source column at a time, by using a first order Markovian process which uses the descriptive features of a source column's two immediate neighbors on either side, which provides context in which a source column appears. The Pointwise Dynamic Conditional Random Field model is first order Markovian in the sense that the model only uses features describing cell contents of the source column under evaluation and features describing the columns that are immediately adjacent to the source column under evaluation. For example, if the Pointwise Dynamic Conditional Random Field model is evaluating the city entity type for a source column, the model will include features that describe the source column's cell contents as the city entity type and the features that describe the cell contents of the source columns that are immediately adjacent to the source column under evaluation as the street entity type and the state entity type. It is more likely the source column for the city entity type to be present after the source column for the street entity type and before the source column for the state entity type. The use of adjacent source columns' feature provides a context in which a source column appears.

Therefore, the proximity of a source column relative to adjacent source columns is evaluated. Some entities typically occur in a specific order. For example, the column first_name is usually immediately to the left of the column last_name Likewise, the columns street, city, state, zip code and country usually occur together, and in that order. Such proximity indicators are well-known for the data model of the database, and can also influence the confidence score. As an example, if a source column scores high for first_name, and the source column to the immediate right of the source column under evaluation scores high for last_name, this proximity is used to increase the scores of both column mappings even more. Thus, if the proximity indicators support the guess, then the confidence score can be increased. If the proximity indicators do not support the guess, then the confidence score can be decreased. For example, a heuristic algorithm can be used to evaluate the cell contents of a source column as containing syntactically well-formed email addresses for most values, such that the probability that the source column corresponds to the predefined email address entity type in the target file may be initially high. However, if the source column to the immediate left of the source column under evaluation is a source column which is typically followed by some other source column—for example, the first_name entity type is typically followed by either the middle_name entity type or the last_name entity type—then this ordering contradicts the initial probability, such that the score can be decreased.

Although the example describes scoring the association of a single source column with a single entity, the Pointwise Dynamic Conditional Random Field model may score the association of many or all of the source columns with corresponding entities. Although the example depicts a posterior score with a value that ranges from 0.0 to 1.0 and describes a predefined entity type as a city entity type, the posterior score may have any value and the predefined entity type may be any entity type, such as first name, last name, title, company, address, city, state, country, email address, phone number, and website.

After associating the source column with an entity, the system optionally determines whether the entity associated with the source column is an undefined entity, block 104. By way of example and without limitation, this can include the system determining that the entity associated with the source column is the city entity type, which is a defined entity type and not an undefined entity type. The system determines how to process the source column based on the entity type that has been identified for the source column's cell content. If the associated entity type is defined, the method 100 continues to block 106 to identify any potential mapping conflicts. If the associated entity type is undefined, the method 100 proceeds to block 116 to process the source column as an undefined entity.

After associating the source column with an entity, and possibly determining whether the entity type is defined, the system optionally determines whether any other source column is associated with the entity that is associated with the source column, block 106. In embodiments, this can include the system determining whether another source column is associated with the city entity type that is associated with the original source column. If a probabilistic evaluation of a source file determines that the first_name entity type appears multiple times, at least some of these mappings are likely wrong. On the other hand, for certain target columns, such as phone and email, a few occurrences in the source file may be acceptable since a contact may have multiple telephone numbers and/or multiple email addresses. Thus, this constraint may be modelled probabilistically, instead of using a hard and fast rule, such as ruling that no target name can occur multiple times. If multiple source columns are associated with the same entity, the method 100 continues to block 108 to resolve the potential mapping conflict for the multiple source columns associated with the same entity. If multiple source columns are not associated with the same entity, the method 100 proceeds to block 110 to map the only source column associated with the entity.

If a potential mapping conflict exists for the source columns associated with the same entity, the system optionally determines whether to resolve the other source column to the entity, block 108. For example and without limitation, this can include the system using a Pairwise Dynamic Conditional Random Field model to determine which of the source columns should be resolved to the city entity type: Since the Pointwise Dynamic Conditional Random Field model predicts one column at a time and only in the context of the source columns that are immediately next to the source column under evaluation, the Pointwise model does not take into account of long range dependencies. Examples of potential mapping conflicts which need to be resolved occur when a spreadsheet has both a toll free phone number and a regular business phone number. In the absence of a regular business phone number, the toll free phone number is a valid phone number, such that the source column for the toll free phone number should be mapped to the phone number entity for the target file. If these two different types of phone numbers were stored in two source columns that were next to each other in the spreadsheet, the potential mapping conflict would have been resolved by the Pointwise Dynamic Conditional Random Field model. Therefore, in this example the Pairwise Dynamic Conditional Random Field model resolves which source column associated with the phone number entity should be mapped to the regular business phone number entity type and which source column associated with the phone number entity should be mapped to the toll free phone number entity type. Other examples of potential mapping conflicts which the Pairwise Dynamic Conditional Random Field Model resolves are between a business email address and a personal email address, and between a business mailing address (which includes a business city) and a personal mailing address (which includes a personal city). If the system determines not to resolve the other source column to the entity, the method 100 continues to block 110 to map the source column to the entity. If the system determines to resolve the other source column to the entity, the method 100 proceeds to block 114 to map the other source column to the entity.

Having associated the source column with the entity, the system creates a mapping of the source column to the target column associated with the entity, block 110. By way of example and without limitation, this can include the system creating a mapping of the original source column to the business city entity target column, which may also include creating a mapping of the other source column to the personal city entity target column.

Having mapped a source column to a target column, the system transforms the mapped source column to the target column in accord with the mapping, block 112. In embodiments, this can include the system transforming the mapped source column to the business city entity target column. Then the method 100 stops for the mapped source column.

Having resolved the other source column to the entity, the system optionally creates a mapping of the other source column to the target column associated with the entity, block 114. For example and without limitation, this can include the system creating a mapping of the other source column to the business city entity target column, which may also include creating a mapping of the original source column to the personal city entity target column. Then the method 100 goes to block 112 to transform the mapped source column.

If an entity associated with a source column is an undefined entity, the system optionally creates a mapping of the source column to the undefined entity, block 116. By way of example and without limitation, this can include the system mapping the source column to an undefined entity because the posterior score of 0.4 for the source column associated the source column with an undefined entity. Such a result can infer that the source column is irrelevant and therefore may be ignored in a post-processing step when the data is actually converted. The system may enable many source columns which might otherwise be associated with undefined entities to be associated with the closest matching entity type instead. If a source column is associated with an entity that is associated with another source column, then the Pairwise Dynamic Conditional Random Field model resolves which source column should be associated with the entity. However, if no other source column is associated with the entity which is associated with a source column, then the system has the option to extract data from this source column that closely resembles the entity type, which helps to prevent any data loss.

If all the source columns have not yet been evaluated, then the system gets the next source column and evaluates the next source column. If all the source columns have been evaluated, then post-processing and conversion of the columns in accord with the mapping will proceed. The question of whether any post-processing steps are required is considered. For example, if one or more source columns need to be ignored, merged or split, then post-processing is required. If post-processing is not required, the source columns are transformed in accord with the mapping scheme and stored in the database. Note this might be an unusual result since some differences may be expected between the source file and the target data model. If post-processing is required, then the system may check to determine if any source columns should be ignored at the actual data transformation stage. Source columns to be ignored will have been mapped to a target column for undefined entities in the analysis stage, and after content analysis evaluated and rejected the possibility that such source columns might contain relevant content to be split or merged, an indicator is set, such as a program flag, to inform the process that this source column should be ignored. The mapping is updated to include an instruction to specifically exclude or remove all columns marked “ignore” when transformation of the data occurs.

If the source column is mapped to an undefined entity, the system optionally merges the source column with an additional source column that is mapped to another undefined entity to create merged source columns that are mapped to a defined entity or optionally splits the source column into at least two split columns that are mapped to at least two defined entities, block 118. In embodiments, this can include the system splitting a source column, which features describe as containing data for both first names and last names, into one column for first name data and another column for last name data, such that these two columns are mapped to the first name entity target column and the last name entity target column, respectively. Source columns requiring a split may be recognized as such during content analysis, and may be identified for special handling. The system also checks for any source columns that need to be merged. Recall the prior example of a pairs of source columns called street1 and street2, thus needing to be merged into the single defined entity address. Source columns requiring a merger may also be recognized as such during content analysis, and may be identified for special handling. For example, a merge routine may be performed to merge a pair of source columns into a single column, which may then be mapped to the corresponding defined entity type. Once all post-processing steps have been considered, then the source columns are transformed in accord with the updated mapping scheme and stored in the database. Then the method 100 goes to block 112 to transform the mapped source column(s).

The method 100 may be repeated as desired. Although this disclosure describes the blocks 102-118 executing in a particular order, the blocks 102-118 may be executed in a different order. In other implementations, each of the blocks 102-118 may also be executed in combination with other blocks and/or some blocks may be divided into a different set of blocks.

FIG. 2 illustrates example source file columns for transforming to a target file, under an embodiment. Table 200 includes columns 202-220. Features describe the cell contents of source column 202 as associated with the first name entity type, features describe the cell contents of source column 204 as associated with the last name entity type, features describe the cell contents of source column 206 as associated with the job title entity type, features describe the cell contents of source column 208 as associated with the email address entity type, and features describe the cell contents of source column 210 as associated with the employer entity type. Similarly, features describe the cell contents of source column 212 as associated with the street entity type, features describe the cell contents of source column 214 as associated with the city entity type, features describe the cell contents of source column 216 as associated with the state entity type, features describe the cell contents of source column 218 as associated with the zip code entity type, and features describe the cell contents of source column 220 as associated with the email address entity type.

The Pointwise Dynamic Conditional Random Field model uses the features describing the cell contents of the adjacent source columns 212-218 to map the adjacent source columns 212-218 to the street entity type, city entity type, state entity type, and zip code entity type, respectively, of the target file. Since both the source column 208 and the source column 220 are associated with the email entity type, the Pairwise Dynamic Conditional Random Field model uses the similarity between the cell contents of the source column 208 associated with the email entity type and the cell contents of the source column 210 associated with the employer entity type to resolve that the source column 208 should be mapped to a business email address entity type, which results in resolving that the source column 220 should be mapped to a personal email address entity type.

### System Overview

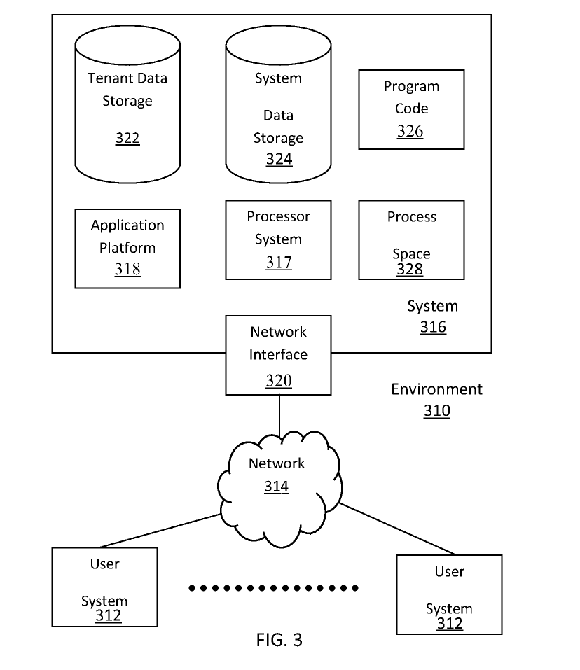

FIG. 3 illustrates a block diagram of an environment 310 wherein an on-demand database service might be used. The environment 310 may include user systems 312, a network 314, a system 316, a processor system 317, an application platform 318, a network interface 320, a tenant data storage 322, a system data storage 324, program code 326, and a process space 328. In other embodiments, the environment 310 may not have all of the components listed and/or may have other elements instead of, or in addition to, those listed above.

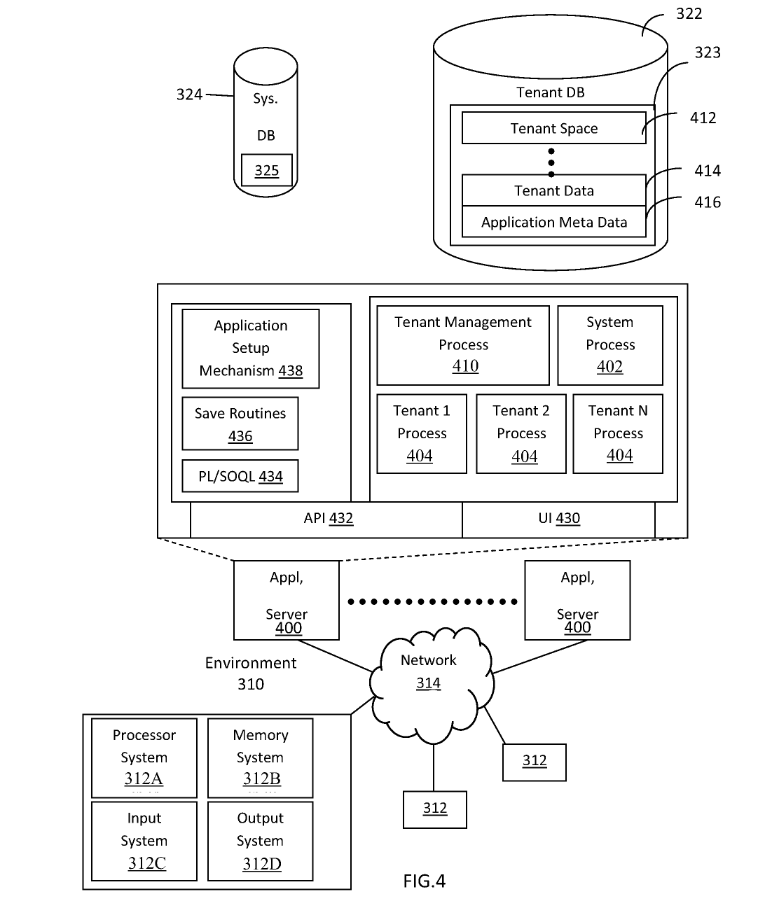

The environment 310 is an environment in which an on-demand database service exists. A user system 312 may be any machine or system that is used by a user to access a database user system. For example, any of the user systems 312 may be a handheld computing device, a mobile phone, a laptop computer, a work station, and/or a network of computing devices. As illustrated in FIG. 3 (and in more detail in FIG. 4) the user systems 312 might interact via the network 314 with an on-demand database service, which is the system 316.

An on-demand database service, such as the system 316, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, the “on-demand database service 316” and the “system 316” will be used interchangeably herein. A database image may include one or more database objects. A relational database management system (RDMS) or the equivalent may execute storage and retrieval of information against the database object(s). The application platform 318 may be a framework that allows the applications of the system 316 to run, such as the hardware and/or software, e.g., the operating system. In an embodiment, the on-demand database service 316 may include the application platform 318 which enables creation, managing and executing one or more applications developed by the provider of the on-demand database service, users accessing the on-demand database service via user systems 312, or third party application developers accessing the on-demand database service via the user systems 312.

The users of the user systems 312 may differ in their respective capacities, and the capacity of a particular user system 312 might be entirely determined by permissions (permission levels) for the current user. For example, where a salesperson is using a particular user system 312 to interact with the system 316, that user system 312 has the capacities allotted to that salesperson. However, while an administrator is using that user system 312 to interact with the system 316, that user system 312 has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

The network 314 is any network or combination of networks of devices that communicate with one another. For example, the network 314 may be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

The user systems 312 might communicate with the system 316 using TCP/IP and, at a higher network level, use other common Internet protocols to communicate, such as HTTP, FTP, AFS, WAP, etc. In an example where HTTP is used, the user systems 312 might include an HTTP client commonly referred to as a “browser” for sending and receiving HTTP messages to and from an HTTP server at the system 316. Such an HTTP server might be implemented as the sole network interface between the system 316 and the network 314, but other techniques might be used as well or instead. In some implementations, the interface between the system 316 and the network 314 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, the system 316, shown in FIG. 3, implements a web-based customer relationship management (CRM) system. For example, in one embodiment, the system 316 includes application servers configured to implement and execute CRM software applications as well as provide related data, code, forms, webpages and other information to and from the user systems 312 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, the system 316 implements applications other than, or in addition to, a CRM application. For example, the system 316 may provide tenant access to multiple hosted (standard and custom) applications, including a CRM application. User (or third party developer) applications, which may or may not include CRM, may be supported by the application platform 318, which manages creation, storage of the applications into one or more database objects and executing of the applications in a virtual machine in the process space of the system 316.

One arrangement for elements of the system 316 is shown in FIG. 3, including the network interface 320, the application platform 318, the tenant data storage 322 for tenant data 323, the system data storage 324 for system data 325 accessible to the system 316 and possibly multiple tenants, the program code 326 for implementing various functions of the system 316, and the process space 328 for executing MTS system processes and tenant-specific processes, such as running applications as part of an application hosting service. Additional processes that may execute on the system 316 include database indexing processes.

Several elements in the system shown in FIG. 3 include conventional, well-known elements that are explained only briefly here. For example, each of the user systems 312 could include a desktop personal computer, workstation, laptop, PDA, cell phone, or any wireless access protocol (WAP) enabled device or any other computing device capable of interfacing directly or indirectly to the Internet or other network connection. Each of the user systems 312 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of the user systems 312 to access, process and view information, pages and applications available to it from the system 316 over the network 314. Each of the user systems 312 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by the system 316 or other systems or servers. For example, the user interface device may be used to access data and applications hosted by the system 316, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each of the user systems 312 and all of its components are operator configurable using applications, such as a browser, including computer code run using a central processing unit such as an Intel Pentium® processor or the like. Similarly, the system 316 (and additional instances of an MTS, where more than one is present) and all of their components might be operator configurable using application(s) including computer code to run using a central processing unit such as the processor system 317, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring the system 316 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, the system 316 is configured to provide webpages, forms, applications, data and media content to the user (client) systems 312 to support the access by the user systems 312 as tenants of the system 316. As such, the system 316 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 4 also illustrates the environment 310. However, in FIG. 4 elements of the system 316 and various interconnections in an embodiment are further illustrated. FIG. 4 shows that the each of the user systems 312 may include a processor system 312A, a memory system 312B, an input system 312C, and an output system 312D. FIG. 4 shows the network 314 and the system 316. FIG. 4 also shows that the system 316 may include the tenant data storage 322, the tenant data 323, the system data storage 324, the system data 325, a User Interface (UI) 430, an Application Program Interface (API) 432, a PL/SOQL 434, save routines 436, an application setup mechanism 438, applications servers 4001-400N, a system process space 402, tenant process spaces 404, a tenant management process space 410, a tenant storage area 412, a user storage 414, and application metadata 416. In other embodiments, the environment 310 may not have the same elements as those listed above and/or may have other elements instead of, or in addition to, those listed above.

The user systems 312, the network 314, the system 316, the tenant data storage 322, and the system data storage 324 were discussed above in FIG. 3. Regarding the user systems 312, the processor system 312A may be any combination of one or more processors. The memory system 312B may be any combination of one or more memory devices, short term, and/or long term memory. The input system 312C may be any combination of input devices, such as one or more keyboards, mice, trackballs, scanners, cameras, and/or interfaces to networks. The output system 312D may be any combination of output devices, such as one or more monitors, printers, and/or interfaces to networks. As shown by FIG. 4, the system 316 may include the network interface 320 (of FIG. 3) implemented as a set of HTTP application servers 400, the application platform 318, the tenant data storage 322, and the system data storage 324. Also shown is the system process space 402, including individual tenant process spaces 404 and the tenant management process space 410. Each application server 400 may be configured to access tenant data storage 322 and the tenant data 323 therein, and the system data storage 324 and the system data 325 therein to serve requests of the user systems 312. The tenant data 323 might be divided into individual tenant storage areas 412, which can be either a physical arrangement and/or a logical arrangement of data. Within each tenant storage area 412, the user storage 414 and the application metadata 416 might be similarly allocated for each user. For example, a copy of a user's most recently used (MRU) items might be stored to the user storage 414. Similarly, a copy of MRU items for an entire organization that is a tenant might be stored to the tenant storage area 412. The UI 430 provides a user interface and the API 432 provides an application programmer interface to the system 316 resident processes to users and/or developers at the user systems 312. The tenant data and the system data may be stored in various databases, such as one or more Oracle™ databases.

The application platform 318 includes the application setup mechanism 438 that supports application developers' creation and management of applications, which may be saved as metadata into the tenant data storage 322 by the save routines 436 for execution by subscribers as one or more tenant process spaces 404 managed by the tenant management process 410 for example. Invocations to such applications may be coded using the PL/SOQL 434 that provides a programming language style interface extension to the API 432. A detailed description of some PL/SOQL language embodiments is discussed in commonly owned U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is incorporated in its entirety herein for all purposes. Invocations to applications may be detected by one or more system processes, which manages retrieving the application metadata 416 for the subscriber making the invocation and executing the metadata as an application in a virtual machine.

Each application server 400 may be communicably coupled to database systems, e.g., having access to the system data 325 and the tenant data 323, via a different network connection. For example, one application server 4001 might be coupled via the network 314 (e.g., the Internet), another application server 400N-1 might be coupled via a direct network link, and another application server 400N might be coupled by yet a different network connection. Transfer Control Protocol and Internet Protocol (TCP/IP) are typical protocols for communicating between application servers 400 and the database system. However, it will be apparent to one skilled in the art that other transport protocols may be used to optimize the system depending on the network interconnect used.

In certain embodiments, each application server 400 is configured to handle requests for any user associated with any organization that is a tenant. Because it is desirable to be able to add and remove application servers from the server pool at any time for any reason, there is preferably no server affinity for a user and/or organization to a specific application server 400. In one embodiment, therefore, an interface system implementing a load balancing function (e.g., an F5 Big-IP load balancer) is communicably coupled between the application servers 400 and the user systems 312 to distribute requests to the application servers 400. In one embodiment, the load balancer uses a least connections algorithm to route user requests to the application servers 400. Other examples of load balancing algorithms, such as round robin and observed response time, also can be used. For example, in certain embodiments, three consecutive requests from the same user could hit three different application servers 400, and three requests from different users could hit the same application server 400. In this manner, the system 316 is multi-tenant, wherein the system 316 handles storage of, and access to, different objects, data and applications across disparate users and organizations.

As an example of storage, one tenant might be a company that employs a sales force where each salesperson uses the system 316 to manage their sales process. Thus, a user might maintain contact data, leads data, customer follow-up data, performance data, goals and progress data, etc., all applicable to that user's personal sales process (e.g., in the tenant data storage 322). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by the system 316 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, the system 316 might also maintain system level data usable by multiple tenants or other data. Such system level data might include industry reports, news, postings, and the like that are sharable among tenants.

In certain embodiments, the user systems 312 (which may be client systems) communicate with the application servers 400 to request and update system-level and tenant-level data from the system 316 that may require sending one or more queries to the tenant data storage 322 and/or the system data storage 324. The system 316 (e.g., an application server 400 in the system 316) automatically generates one or more SQL statements (e.g., one or more SQL queries) that are designed to access the desired information. The system data storage 324 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, filed Apr. 2, 2004, entitled “Custom Entities and Fields in a Multi-Tenant Database System”, which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A system for transforming columns from source files to target files, the apparatus comprising:
one or more processors; and
a non-transitory computer readable medium storing a plurality of instructions, which when executed, cause the one or more processors to:
associate a source column in a source file with an entity of a plurality of entities associated with a plurality of target columns comprising a target file, wherein the association is based on a first set of features that describes contents of cells of a first source column that is adjacent to the source column, a second set of features that describes contents of cells of a second source column that is adjacent to the source column, and a third set of features that describes contents of cells of the source column;
create a mapping of the source column to a target column associated with the entity; and
transform the mapped source column to the target column in accord with the mapping.

2. The system of claim 1, wherein associating the source column with the entity comprises:
for each cell in a subset of cells in the source column, assigning a cell score to a likelihood that contents of a corresponding cell in the source column indicate that the source column corresponds with the entity; and
aggregating cell scores of each cell in the subset.

3. The system of claim 1, wherein a dynamic conditional random field model associates the source column with the entity.

4. The system of claim 1, wherein associating the source column with the entity is further based on an ordered subset of the plurality of entities.

5. The system of claim 1, comprising further instructions, which when executed, cause the one or more processors to:
determine whether an other source column is associated with the entity associated with the source column;
determine whether to resolve the other source column to the predefined entity in response to a determination that the other source column is associated with the entity associated with the source column; and
create a mapping of the other source column to the target column associated with the entity in response to a determination to resolve the other source column to the entity.

6. The system of claim 1, comprising further instructions, which when executed, cause the one or more processors to:
determine whether the entity associated with the source column comprises an undefined entity; and
create a mapping of the source column to the undefined entity in response to a determination that the entity associated with the source column comprises the undefined entity.

7. The system of claim 6, comprising further instructions, which when executed, cause the one or more processors to one of merge the source column with an additional source column that is mapped to another undefined entity, thereby creating merged source columns that are mapped to one of the plurality of entities, and split the source column into at least two split columns that are mapped to at least two of the plurality of entities.

8. A computer program product comprising computer-readable program code to be executed by one or more processors when retrieved from a non-transitory computer-readable medium, the program code including instructions to:
associate a source column in a source file with an entity of a plurality of entities associated with a plurality of target columns comprising a target file, wherein the association is based on a first set of features that describes contents of cells of a first source column that is adjacent to the source column, a second set of features that describes contents of cells of a second source column that is adjacent to the source column, and a third set of features that describes contents of cells of the source column;
create a mapping of the source column to a target column associated with the entity; and
transform the mapped source column to the target column in accord with the mapping.

9. The computer program product of claim 8, wherein associating the source column with the entity comprises:
for each cell in a subset of cells in the source column, assigning a cell score to a likelihood that contents of a corresponding cell in the source column indicate that the source column corresponds with the entity; and
aggregating cell scores of each cell in the subset.

10. The computer program product of claim 8, wherein a dynamic conditional random field model associates the source column with the entity.

11. The computer program product of claim 8, wherein associating the source column with the entity is further based on an ordered subset of the plurality of entities.

12. The computer program product of claim 8, wherein the program code comprises further instructions to:
determine whether an other source column is associated with the entity associated with the source column;
determine whether to resolve the other source column to the entity in response to a determination that the other source column is associated with the entity associated with the source column; and
create a mapping of the other source column to the target column associated with the entity in response to a determination to resolve the other source column to the entity.

13. The computer program product of claim 8, wherein the program code comprises further instructions to:
determine whether the entity associated with the source column comprises an undefined entity; and
create a mapping of the source column to the undefined entity in response to a determination that the entity associated with the source column comprises the undefined entity.

14. The computer program product of claim 13, wherein the program code comprises further instructions to one of merge the source column with an additional source column that is mapped to another undefined entity, thereby creating merged source columns that are mapped to one of the plurality of entities, and split the source column into at least two split columns that are mapped to at least two of the plurality of entities.

15. A method for transforming columns from source files to target files, the method comprising:
associating a source column in a source file with an entity of a plurality of entities associated with a plurality of target columns comprising a target file, wherein the association is based on a first set of features that describes contents of cells of a first source column that is adjacent to the source column, a second set of features that describes contents of cells of a second source column that is adjacent to the source column, and a third set of features that describes contents of cells of the source column;
creating a mapping of the source column to a target column associated with the entity; and
transforming the mapped source column to the target column in accord with the mapping.

16. The method of claim 15, wherein associating the source column with the entity comprises:
for each cell in a subset of cells in the source column, assigning a cell score to a likelihood that contents of a corresponding cell in the source column indicate that the source column corresponds with the entity; and
aggregating cell scores of each cell in the subset.

17. The method of claim 15, wherein a dynamic conditional random field model associates the source column with the entity.

18. The method of claim 15, wherein associating the source column with the entity is further based on an ordered subset of the plurality of entities.

19. The method of claim 15, wherein the method further comprises:
determining whether an other source column is associated with the entity associated with the source column;
determining whether to resolve the other source column to the entity in response to a determination that the other source column is associated with the entity associated with the source column; and
creating a mapping of the other source column to the target column associated with the entity in response to a determination to resolve the other source column to the entity.

20. The method of claim 15, wherein the method further comprises:
determining whether the entity associated with the source column comprises an undefined entity:
creating a mapping of the source column to the undefined entity in response to a determination that the entity associated with the source column comprises the undefined entity: and
one of merging the source column with an additional source column that is mapped to another undefined entity, thereby creating merged source columns that are mapped to one of the plurality of entities, and splitting the source column into at least two split columns that are mapped to at least two of the plurality of entities.
